(19) United States
(12) Patent Application Publication
(10) Pub. No.: US 2012/0305797 A1
(43) Pub. Date: Dec. 6, 2012

(54) METHOD AND PARTICLE BEAM DEVICE FOR FOCUSING A PARTICLE BEAM

(76) Inventor: Dirk PREIKSZAS, Oberkochen (DE)

(21) Appl. No.: 13/483,614

(22) Filed: May 30, 2012

(30) Foreign Application Priority Data
Jun. 1, 2011 (DE) 10 2011 076 893.9

(51) Int. Cl. H01J 3/14

(52) U.S. Cl. 250/397

(57) ABSTRACT

A system is provided for focusing a particle beam onto an irradiation position on a surface of an object and for imaging and/or processing the surface. The described system is based on the consideration that the focusing of a particle beam generated in the particle beam device onto the surface of an object is intended to be effected in a manner dependent on the height profile of the surface. Accordingly, parameters for setting the focusing in a manner dependent on the height profile of the surface should be chosen. During scanning of the particle beam over the surface of the object, the focusing for each scanning point is set using the parameters in such a way that the best possible focusing can be achieved. In order to achieve this, the described system provides for taking account of the height profile of the surface of the object when choosing the parameters.

### TECHNICAL FIELD

This application relates to a method for focusing a particle beam onto an irradiation position on a surface of an object and for imaging and/or processing the surface. Furthermore, this application also relates to a particle beam device in which the described method is used.

### BACKGROUND OF THE INVENTION

Electron beam devices, in particular a scanning electron microscope (also called SEM hereinafter) and/or a transmission electron microscope (also called TEM hereinafter), are used for examining objects (samples) in order to obtain insights with regard to the properties and behavior of said objects under specific conditions.

In the case of an SEM, an electron beam (also called primary electron beam hereinafter) is generated using a beam generator and focused by a beam guiding system, in particular an objective lens, onto an object to be examined. Using a deflection device, the primary electron beam is guided in a raster-type fashion over a surface of the object to be examined. In this case, the electrons of the primary electron beam interact with the material of the object to be examined. As a consequence of the interaction, in particular electrons are emitted from the surface of the object to be examined (so-called secondary electrons) and electrons of the primary electron beam are backscattered (so-called backscattered electrons). The secondary electrons and backscattered electrons are detected and used for image generation. An imaging of the surface of the object to be examined is thus obtained.

In the case of a TEM, a primary electron beam is likewise generated using a beam generator and focused using a beam guiding system onto an object to be examined. The primary electron beam radiates through the object to be examined. During the passage of the primary electron beam through the object to be examined, the electrons of the primary electron beam interact with the material of the object to be examined. The electrons passing through the object to be examined are imaged onto a luminescence screen or onto a detector (for example a camera) by a system consisting of an objective lens and a projection lens. In addition, for this purpose provision can be made for detecting electrons backscattered at the object to be examined and/or secondary electrons emitted by the object to be examined using a further detector, in order to image an object to be examined. In this case, the imaging is effected in the scanning mode of a TEM. A TEM of this type is generally designated as STEM.

A particle beam guided onto an object, for example an electron beam, can, in addition to the interaction particles already mentioned above, also interact with the object in such a way that electromagnetic radiation in the form of cathodoluminescence arises. By detecting and evaluating the cathodoluminescence (for example using an intensity and spectral analysis), it is possible to determine properties of the material of the object, for example the determination of recombination centers, lattice defects, impurities and phase formations. The above enumeration should be understood to be by way of example and not exhaustive.

An object to be examined generally has no surface that can be designated as totally planar. However, the surface has a structure given by numerous peaks and valleys. If such a surface is intended to be examined using a particle beam device with such a high resolution that the structure of said surface is intended to become visible, it is known from the prior art to subdivide the position of the particle beam into two dimensions (for example into a first dimension in the form of an x-extent and for example into a second dimension in the form of a y-extent). The parameters for focusing the particle beam in the first dimension are fixedly set. They are not varied further. By contrast, the parameters of the focusing of the particle beam in the second dimension can be readjusted. This means that parameters for setting the focusing of the particle beam cannot be identical for every position on the surface of the object. A refocusing of the particle beam is known from the prior art also for surfaces of an object to be examined that are inclined with respect to the optical axis of the particle beam device.

The prior art also discloses a particle beam device comprising an image aberration correction device. The image aberration correction device serves to compensate for image aberrations that arise during the focusing of the particle beam onto the object. Accordingly, the image aberration correction device serves to increase the resolution of imagings of an object to be examined using the particle beam device. By way of example, the image aberration correction device compensates for image aberrations generated in the objective lens of the particle beam device. Such image aberrations occur, for example, when the particle beam passes through the objective lens at a finite aperture angle along the optical axis of the particle beam device. An image aberration correction device is known from U.S. Pat. No. 7,223,983 B2, for example, which is incorporated herein by reference. It has been found, however, that when the resolution is increased, the aperture angle of the particle beam should be enlarged. However, this causes the achievable depth of focus to become smaller, since the depth of focus is inversely proportional to the aperture angle. The smaller the aperture angle, the greater the achievable depth of focus. Accordingly, it is not always ensured that a sufficiently sharp imaging of the object to be examined is achieved over a large region of an object to be examined.

Accordingly, it would be desirable to address the problem of specifying a method and a particle beam device for focusing a particle beam which make possible a sufficiently sharp imaging of an object to be examined over a predefinable region of the object to be examined.

### SUMMARY OF THE INVENTION

According to the system described herein, a method is provided for focusing a particle beam onto an irradiation position on a surface of an object and for imaging and/or processing the surface of the object. The surface is distinguished by the fact that the surface extends along a first axis (x-axis) and along a second axis (y-axis). By way of example, the surface may be embodied as a scanning surface composed of a plurality of scanning points. Each scanning point of the scanning surface may be, for example, an irradiation position onto which the particle beam is focused, as will be explained herein. In an embodiment of the method according to the system described herein, firstly the particle beam is generated, for example an electron beam or an ion beam. Furthermore, the height of the object is determined at different locations (for example the abovementioned scanning points) on the surface (for example the abovementioned scanning surface) of the object. Thus, provision is made for determining at least one first object height, which extends along a third axis (z-axis), at at least one first location on the surface. Furthermore, at least one second object height, which extends along the third axis (z-axis), is determined at least one second location on the surface. Moreover, at least one third object height, which extends along the third axis (z-axis), is determined at at least one third location on the surface. In this case, provision is made, for example, for the first axis, the second axis and the third axis in each case to be oriented perpendicularly to one another. Other exemplary embodiments provide for at least one of the abovementioned axes, namely the first axis, the second axis and the third axis, to be arranged at an angle that is different from 90° with respect to at least one other of the abovementioned axes, namely the first axis, the second axis and the third axis.

The object heights determined may serve for determining parameters used for focusing the particle beam onto the object. Thus, an embodiment of the method according to the system described herein provides for determining at least one first focusing parameter (also called f₀ hereinafter) using at least one of the object heights, namely the first object height, the second object height and the third object height. Furthermore, at least one first correction parameter (also called fₓ hereinafter) is determined using at least one of the object heights, namely the first object height, the second object height and the third object height. Furthermore, at least one second correction parameter (also called f_{y} hereinafter) is determined using at least one of the object heights, namely the first object height, the second object height and the third object height. The method according to system described herein also comprises guiding the particle beam to the irradiation position (for example one of the abovementioned scanning points) on the surface (for example the abovementioned scanning surface). The irradiation position is predefined by a first position (x) relative to the first axis (x-axis) and by a second position (y) relative to the second axis (y-axis). A second focusing parameter (also called fₓ*x hereinafter) is determined using the first correction parameter (fₓ) and the first position (x). Furthermore, a third focusing parameter (also called f_{y}*y hereinafter) is determined using the second correction parameter (f_{y}) and the second position (y). The particle beam is then focused at the irradiation position in a manner dependent on the first focusing parameter (f₀), the second focusing parameter (fₓ*x) and the third focusing parameter (f_{y}*y). At the irradiation position, the object can then be processed using the particle beam. In addition or as an alternative thereto, provision is made for detecting interaction particles and/or interaction radiation originating from the irradiation position. The interaction particles and/or the interaction radiation arise(s) on account of an interaction of the particle beam with the object at the irradiation position.

According further to the system described herein, a method is provided for focusing a particle beam onto an irradiation position on a surface of an object and for imaging and/or processing the surface, wherein the surface extends along a first axis (x-axis) and along a second axis (y-axis). Here, too, provision is made, for example, for the surface to be embodied as a scanning surface composed of a plurality of scanning points. Each of the scanning points can be embodied as an irradiation position. In an embodiment, the further method, too, comprises generating the particle beam and determining object heights, which extend along a third axis (z-axis), at a plurality of locations on the surface. Furthermore, the object heights determined and the plurality of locations are stored in a database, wherein each of the object heights determined is stored in a manner dependent on that location of the plurality of locations at which it was determined. Consequently, an object height determined is assigned to each location stored in the database.

An embodiment of the further method according to the system described herein also provides for determining the irradiation position on the surface, wherein the irradiation position is predefined by a first position (x) relative to the first axis (x-axis) and by a second position (y) relative to the second axis (y-axis). Furthermore, at least three object heights are determined from the database, namely a first object height, a second object height and a third object height. These then serve for determining parameters which are used for focusing. Thus, at least one first focusing parameter (f₀) is determined using at least one of the object heights, namely the first object height, the second object height and the third object height. Moreover, at least one first correction parameter (fₓ) is determined using at least one of the object heights, namely the first object height, the second object height and the third object height. Provision is also made for determining at least one second correction parameter (f_{y}) using at least one of the object heights, namely the first object height, the second object height and the third object height. Furthermore, provision is made for determining a second focusing parameter (fₓ*x) using the first correction parameter (fₓ) and the first position (x). Furthermore, a third focusing parameter (f_{y}*y) is determined using the second correction parameter (f_{y}) and the second position (y). The particle beam is focused at the irradiation position in a manner dependent on the first focusing parameter (f₀), the second focusing parameter (fₓ*x) and the third focusing parameter (f_{y}*y). The object can then be processed at the irradiation position. Additionally or alternatively, provision is made for detecting interaction particles and/or interaction radiation originating from the irradiation position. The interaction particles and/or the interaction radiation arise(s) once again on account of an interaction of the particle beam with the object at the irradiation position.

It is explicitly pointed out that the order of the individual steps of the methods described need not necessarily be implemented in the manner described above. Rather, the order of individual steps of the method according to the system described herein may also be chosen differently in a suitable manner.

The system described herein is based on the consideration that the focusing of a particle beam generated in a particle beam device onto a surface of an object is intended to be effected in a manner dependent on the height profile of the surface, in order that the best possible focusing can be effected. Accordingly, parameters for setting the focusing should be chosen in a manner dependent on the height profile of the surface. During scanning of the particle beam over the surface of the object (that is to say when the particle beam is guided from a first scanning point from a multiplicity of scanning points to a second scanning point from the multiplicity of scanning points), the focusing for each scanning point is set using the parameters in such a way that the best possible focusing can be achieved. In order to achieve this, the system described herein provides for taking account of the height profile of the surface of the object when choosing the parameters. Considerations have revealed that the height profile of the surface of the object can be represented by a series expansion in the form of a Taylor series:

h(x,y)=h₀+hₓ·x+h_{y}·y+h_{xy}·x·y+hₓₓ·x²+h_{yy}·y²+O(3) equation [1]

The series element O(3) of the Taylor series contains terms of the third order and further higher orders of the Taylor series. Further considerations have revealed that terms of the third order of the Taylor series (and also terms of higher orders than the third order) need not be taken into consideration for an approximate description of the height profile of the surface. Accordingly, the height profile of the surface can be approximately described as follows:

h(x,y)=h₀+hₓ·x+h_{y}·y+h_{xy}·x·y+hₓₓ·x²+h_{yy}·y² equation [2].

The methods according to embodiments of the system described herein are based on the further consideration, then, that the focusing of the particle beam, for example using an objective lens of the particle beam device and/or a focusing device, for each scanning point of a scanning region, by taking account of the series elements up to the first order of equation 2, but if appropriate also up to the second order of equation 2, can be set in such a way that a good focusing is achievable. For this purpose, a focusing function is chosen which describes the focusing at a position (x, y) of the surface which is matched to the representation of the height profile and which is given by focusing parameters:

f(x,y)=f₀+fₓ·x+f_{y}·y equation [3]

wherein
f₀ is the first focusing parameter in the form of a basic focusing of the particle beam at the position (x, y) of the surface,
fₓ·x is the second focusing parameter in the form of a focusing of the particle beam along the first axis (x-axis), and wherein
f_{y}·y is the third focusing parameter in the form of a focusing of the particle beam along the second axis (y-axis).

The methods according to embodiments of the system described herein are furthermore based on the consideration that this focusing function should be dependent on the height profile. For this reason, the system described herein is based on the assumption that the following conditions hold true for equation 3:

f₀=h₀ condition [1],

fₓ=hₓ condition [2], and

f_{y}=h_{y} condition [3].

When choosing these conditions, it is assumed that the focusing is only linearly dependent on the position on the surface of the object. Considerations have revealed that this approximation taking account of the linear dependence is sufficient for setting the focusing at a specific position on the surface of the object.

The abovementioned considerations have ensured, then, that the first focusing parameter, the second focusing parameter and the third focusing parameter can always be chosen in such a way that a good focusing of the particle beam is achievable at any position on the surface (for example a scanning point). In this case, the focusing parameters are chosen in a manner dependent on the position on the surface and the height profile.

The methods according to embodiments of the system described herein also ensure that when an image aberration correction device is used for increasing the resolution of imagings of an object to be examined using the particle beam device, despite the smaller depth of focus caused thereby, a focusing is always chosen in such a way that a sharp imaging of the surface of the object is achievable over the entire scanning region of the object.

In a method according to another embodiment of the system described herein, provision is additionally or alternatively made for predefining at least one distance, and for determining at least one first location, at least one second location and at least one third location from the database. In this case, it is provided that at least one of the following locations, namely the first location, the second location and the third location, is spaced apart at the predefined distance from the irradiation position or is arranged in a region which extends from the irradiation position as far as the distance. Furthermore, the first object height is provided by the object height determined at the first location, the second object height is provided by the object height determined at the second location, and the third object height is provided by the object height determined at the third location.

Embodiments of the methods according to the system described herein are based on the following considerations. The particle beam is scanned over the scanning points of the scanning region more rapidly along one of the axes (for example the first axis—that is to say the x-axis) than along the further axis (for example the second axis—that is to say the y-axis). Furthermore, if the particle beam is guided along the first axis (x-axis) over the individual scanning points of the scanning region, the focusing along the first axis (x-axis) is influenced on account of equation 3, in particular on account of the second focusing parameter (fₓ·x). The second focusing parameter is accordingly independent of the position of the irradiation position along the second axis (y-axis). Considerations have revealed that the second focusing parameter could also be made dependent on the irradiation position relative to the second axis (y-axis), in order thus to achieve a better focusing at the irradiation position. In this exemplary embodiment of the methods according to the system described herein, it is therefore assumed that the focusing function in the form of equation 3 is developed as follows:

f(x,y)=f₀+fₓ·x+f_{y}·y+f_{xy}·x·y=f₀+(fₓ+f_{xy}·y)·x+f_{y}·y equation [4]

Consequently, the second focusing parameter in the form of (fₓ+f_{xy}·y) now also has a dependence with respect to the second axis (y-axis). In other words, the gradient in the x-direction is linearly dependent on the respective y-position of the respective irradiation position. The product f_{xy}·x·y ensures that the term f_{xy} itself makes no contribution being different to zero to the second focusing parameter on the first axis and the second axis.

Proceeding from the considerations mentioned above, the method in accordance with another embodiment of the system described herein may also additionally or alternatively comprise the following further steps:
determining at least one fourth object height, which extends along the third axis (z-axis), at at least one fourth location on the surface,
determining at least one third correction parameter (f_{xy}) using at least one of the object heights, namely the first object height, the second object height, the third object height and the fourth object height,
determining a fourth focusing parameter (f_{xy}*x*y) using the third correction parameter (f_{xy}), the first position (x) and the second position (y), and
additionally focusing the particle beam at the irradiation position in a manner dependent on the fourth focusing parameter (f_{xy}*x*y).

Furthermore, in other embodiments, it is additionally or alternatively provided that the first object height, the second object height, the third object height and/or the fourth object height are stored in a database. In a further embodiment, it is additionally or alternatively provided that the surface of the object is delimited by at least one edge and the method comprises one of the following steps:
at least one of the following locations, namely the first location, the second location, the third location, and/or the fourth location, is predefined in such a way that it is arranged in the surface; or
at least one of the following locations, namely the first location, the second location, the third location and/or the fourth location, is predefined in such a way that it is arranged outside the surface.

A further embodiment of a method according to the system described herein may also be based on the considerations mentioned above. This embodiment may additionally or alternatively provide for providing the method with the following steps:
determining a fourth object height from the stored object heights, which extends along the third axis (z-axis),
determining at least one third correction parameter (f_{xy}) using at least one of the object heights, namely the first object height, the second object height, the third object height and the fourth object height,
determining a fourth focusing parameter (f_{xy}*x*y) using the third correction parameter (f_{xy}), the first position (x) and the second position (y), and
additionally focusing the particle beam at the irradiation position in a manner dependent on the fourth focusing parameter (f_{xy}*x*y).

In a further embodiment of the above method, it is further provided that the surface is delimited by at least one edge, and that additionally or alternatively the following steps are provided:
at least one of the plurality of locations is predefined in such a way that it is arranged in the surface; or
at least one of the plurality of locations is predefined in such a way that it is arranged outside the surface.

Functions of the individual focusing parameters have already been described above. At this juncture it is once again explicitly pointed out that focusing the particle beam at the irradiation position in a manner dependent on the first focusing parameter (f₀) comprises a basic focusing of the particle beam at the irradiation position. Furthermore, focusing the particle beam at the irradiation position in a manner dependent on the second focusing parameter (fₓ*x) comprises focusing along the first axis (x-axis). Moreover, focusing the particle beam at the irradiation position in a manner dependent on the third focusing parameter (f_{y}*y) comprises focusing along the second axis (y-axis).

In further embodiments of the methods according to the system described herein, it is additionally or alternatively provided that at least one particle-optical unit, for example an objective lens and/or a further focusing unit, is used for focusing the particle beam. As already mentioned above, provision is furthermore made for using an image aberration correction device. The image aberration correction device serves to compensate for image aberrations that arise during the focusing of the particle beam onto the object. Accordingly, the image aberration correction device serves to increase the resolution of imagings of an object to be examined using the particle beam device. By way of example, the image aberration correction device compensates for image aberrations generated in the objective lens of the particle beam device.

The system described herein also relates to a computer program product comprising a program code which can be loaded into a control processor of a particle beam device and which, upon execution in the control processor, controls the particle beam device in such a way that a method is carried out which comprises at least one of the above-mentioned features or a combination of at least two of the abovementioned features.

The system described herein furthermore relates to a particle beam device comprising at least one beam generator for generating a particle beam, and at least one focusing device for focusing the particle beam onto a surface of an object. Furthermore, the particle beam device according to the system described herein is provided with at least one microprocessor (for example a control processor) having the above computer program product.

An embodiment of the particle beam device according to the system described herein provides for the focusing device to be embodied as an objective lens. As an alternative thereto, provision is made for the particle beam device according to the system described herein to have an objective lens in addition to the focusing device.

In a further embodiment of the particle beam device according to the system described herein, it is additionally or alternatively provided that the particle beam device has at least one deflection device. Furthermore, an image aberration correction device is arranged between the deflection device and the focusing device. The image aberration correction device serves to compensate for image aberrations that arise during the focusing of the particle beam onto the object. By way of example, the image aberration correction device has a plurality of electrostatic and magnetic multi-pole elements. However, the embodiment of the image aberration correction device is not restricted to the embodiment mentioned above. Rather, the image aberration correction device can assume any suitable configuration.

The particle beam device according to the system described herein may be embodied, for example, as an electron beam device, in particular as a scanning electron microscope or as a transmission electron microscope. As an alternative thereto, provision is made for embodying the particle beam device as an ion beam device. Yet another embodiment provides for the particle beam device to be embodied as a combination device having both an electron beam column and an ion beam column.

### BRIEF DESCRIPTION OF THE DRAWINGS

Embodiments of the system described herein are explained in greater detail below on the basis of the figures, in which:

FIG. 1 shows a schematic illustration of a first exemplary embodiment of a particle beam device according to the system described herein;

FIGS. 2A, 2B and 2C show schematic illustrations of an object to be examined;

FIG. 3 shows a schematic illustration of a second exemplary embodiment of a particle beam device according to the system described herein;

FIGS. 4A and 4B show a schematic illustration of a flowchart of an exemplary embodiment of the method according to the system described herein;

FIG. 5 shows a schematic illustration of a flowchart of a further exemplary embodiment of the method according to the system described herein;

FIG. 6 shows a schematic illustration of a flowchart of steps for determining object heights;

FIG. 7 shows a schematic illustration of a third exemplary embodiment of a particle beam device according to the system described herein;

FIG. 8 shows a schematic illustration of a flowchart of a modified method according to FIGS. 4A and 4B; and

FIG. 9 shows a schematic illustration of a flowchart of a modified method according to FIG. 5.

### DETAILED DESCRIPTION OF VARIOUS EMBODIMENTS

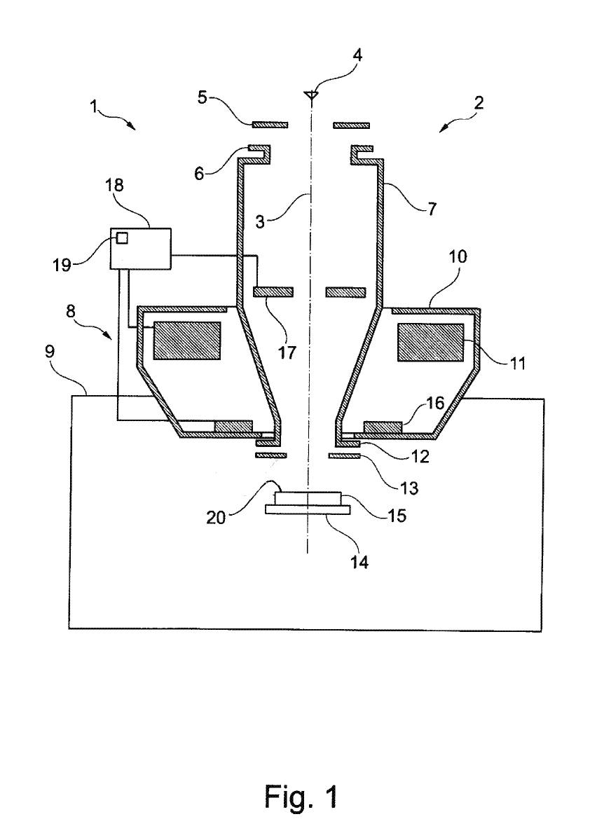

FIG. 1 shows a schematic illustration of a particle beam device 1 in the form of an SEM comprising a particle beam column 2, which is embodied as an electron beam column. However, at this juncture already it is expressly pointed out that the system described herein is not restricted to an SEM. Rather, the system described herein may be used for any particle beam device, in particular for an ion beam device.

The particle beam column 2 has an optical axis 3, a beam generator 4 in the form of an electron source (cathode), a first electrode 5 in the form of an extraction electrode, and a second electrode 6 in the form of an anode, which simultaneously forms one end of a beam guiding tube 7. By way of example, the beam generator 4 is a thermal field emitter. Electrons that emerge from the beam generator 4 are accelerated to anode potential on account of a potential difference between the beam generator 4 and the second electrode 6. Accordingly, a particle beam in the form of an electron beam is provided.

Furthermore, the particle beam device 1 comprises an objective lens 8, which projects into a sample chamber 9 of the particle beam device 1. The objective lens 8 has a hole through which the beam guiding tube 7 is led. The objective lens 8 is furthermore provided with pole shoes 10, in which a coil 11 is arranged. An electrostatic delay device is arranged downstream of the beam guiding tube 7. Said electrostatic delay device has a tube electrode 12 forming one end of the beam guiding tube 7. Furthermore, the electrostatic delay device has an individual electrode 13 arranged adjacent to the tube electrode 12 along the optical axis 3. A sample carrier 14, on which an object 15 to be examined and/or to be processed is arranged, is arranged in the sample chamber 9.

The tube electrode 12 together with the beam guiding tube 7 is at anode potential, while the individual electrode 13 and the object 15 are at a lower potential relative to the anode potential. In this way, the electrons of the particle beam can be decelerated to a desired energy required for the examination and/or processing of the object 15 arranged on the sample carrier 14.

For imaging purposes, secondary electrons and/or backscattered electrons that arise on account of interactions of the particle beam with the object 15 are detected using a detector 17 arranged in the beam guiding tube 7. The signals generated by the detector 17 are communicated for imaging purposes to an electronic unit 18 comprising a microprocessor 19, which is designed for imaging purposes and forwards signals to a monitor (not illustrated).

The particle beam column 2 additionally comprises a scanning device 16, which deflects the particle beam, such that the particle beam can be scanned over the object 15 arranged on the sample carrier 14. The scanning device 16 is connected to the electronic unit 18 and the microprocessor 19 thereof for the purpose of controlling scanning of the particle beam over a scanning surface of the object 15. The scanning surface of the object 15 comprises a plurality of scanning points to which the particle beam can be guided using the scanning device 16.

The objective lens 8 focuses the particle beam onto a surface 20 of the object 15. For this purpose, the coil 11 of the objective lens 8 is connected to the electronic unit 18. The electronic unit 18 drives the coil 11 and thus ensures that the particle beam is focused onto the surface 20.

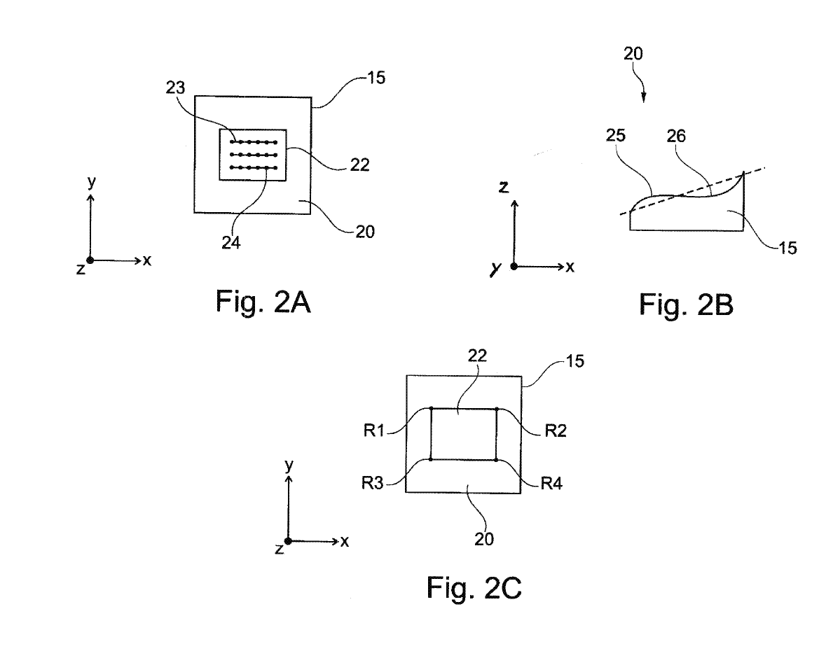

FIG. 2A shows a plan view of the surface 20 of the object 15 which is directed in the direction of the particle beam. Arranged on the surface 20 is a scanning surface 22, the alignment and position of which on the surface 20 can be chosen as necessary. The surface 20 and the scanning surface 22 extend along a first axis in the form of an x-axis and along a second axis in the form of a y-axis. The x-axis and the y-axis are oriented perpendicular to one another. Furthermore, a third axis in the form of the z-axis is also provided, which is oriented perpendicular to the x-axis and the y-axis. The z-axis will be discussed in greater detail further below.

The scanning surface 22 comprises that part of the surface 20 which is imaged and/or processed by the particle beam. The scanning surface 22 comprises a multiplicity of scanning lines 23 at which scanning points 24 are in turn arranged.

FIG. 2A schematically illustrates three scanning lines 23 arranged parallel to one another. It is pointed out that the number of scanning lines 23 may perfectly well be smaller or larger. This also applies to the scanning points 24 illustrated. Furthermore, for the system described herein firstly it is not absolutely necessary for the scanning lines 23 to be embodied in rectilinear fashion, and secondly it is not absolutely necessary for said lines to be arranged parallel to one another. Rather, the scanning lines 23 can assume any suitable shape.

FIG. 2B shows, in a schematic side view, the object 15 with its surface 20. In general, the surface 20 of the object 15 is not embodied in totally planar fashion, but rather has a structure characterized by elevations 25 and depressions 26. They are illustrated in an exaggerated fashion in FIG. 2B. Said elevations 25 and depressions 26 represent a height profile of the surface 20, which can be approximated by equation 3 mentioned above. The elevations 25 and depressions 26 extend along the z-axis. In order to image the scanning surface 22 with a high resolution, it is desirable for the focusing of the particle beam to be set for each scanning point 24 in such a way that the particle beam is focused as well as possible onto the scanning point 24. On account of the structure of the scanning surface 22, therefore, the focusing should be effected in a manner dependent on the given height profile of the scanning surface 22. This will be explained in even greater detail further below.

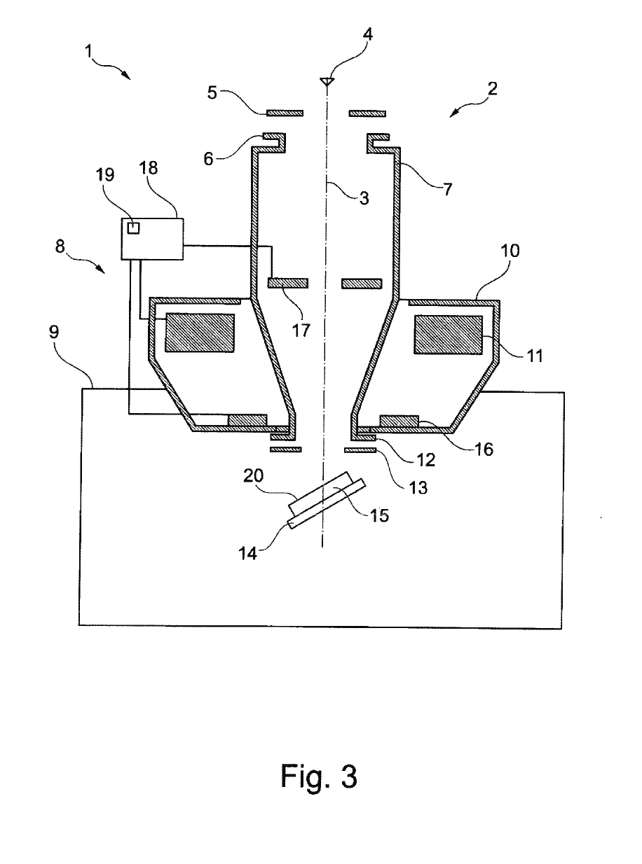

FIG. 3 shows a further embodiment of a particle beam device based on the embodiment from FIG. 1. Identical components are therefore provided with identical reference signs. The embodiment in FIG. 3 differs from the embodiment from FIG. 1 only to the effect that the sample carrier 14 is arranged in a manner inclined with respect to the optical axis 3, such that the object 15 arranged on the sample carrier 14 is also arranged in a manner inclined with respect to the optical axis 3. Even assuming that the surface 20 and a scanning surface 22 arranged on the surface 20 were embodied in a totally planar fashion, then the distance from each scanning point 24 on the scanning surface 22 to the objective lens 8 is different. In order to achieve a sufficient focusing of the particle beam onto each of the scanning points 24, it is desirable if the focusing of the particle beam is set in a manner dependent on the distance from each scanning point 24 to the objective lens 8. Basically, the different distances from the scanning points 24 to the objective lens 8 are also nothing more than the height profile already discussed previously. An additional factor is that the assumption that the surface 20 of the object 15 is totally planar is not correct. Rather, the surface 20 basically has the same structure as illustrated in FIG. 2B.

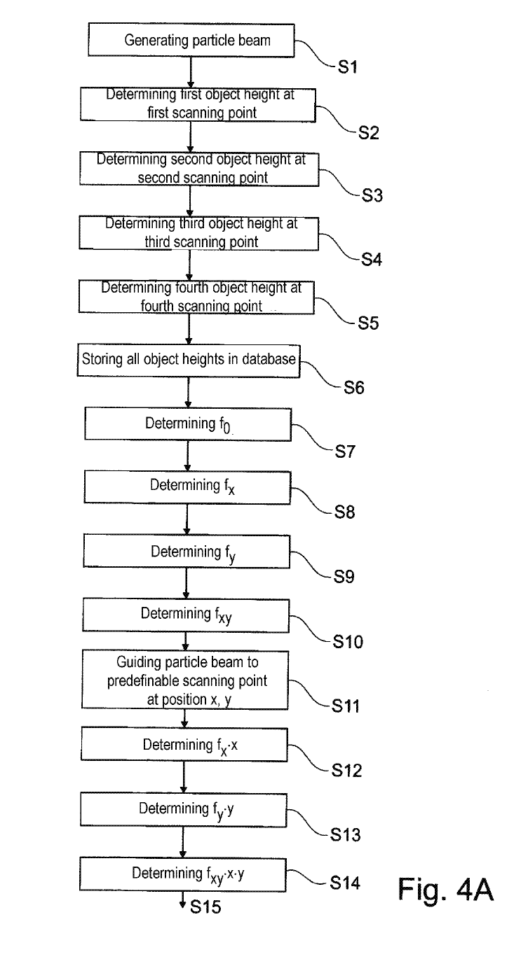

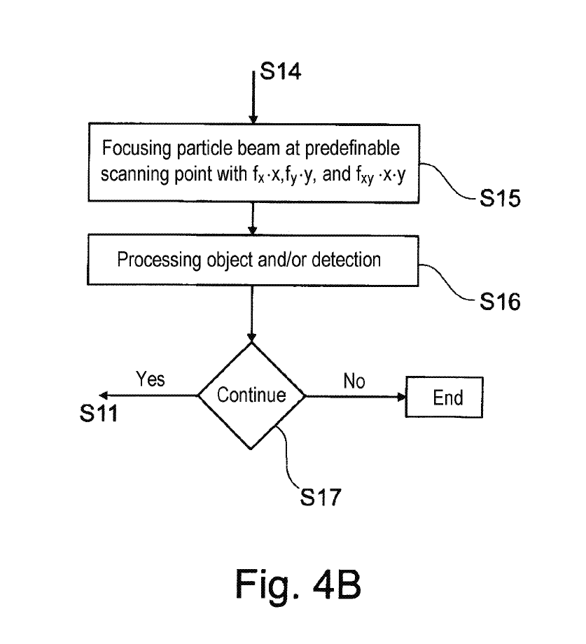

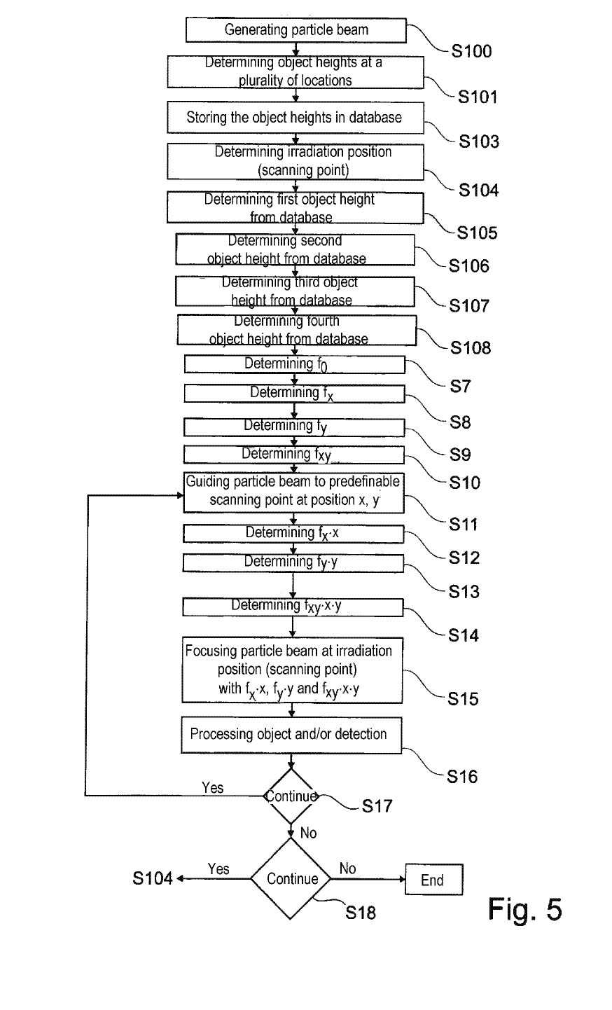

FIGS. 4A and 4B show a first exemplary embodiment of a method according to the system described herein. A computer program product comprising a program code that is loaded into the microprocessor 19 of the electronic unit 18 carries out the method upon execution.

In a step S1, firstly a particle beam in the form of an electron beam is generated by the beam generator 4. Afterward, in steps S2 to S5, object heights are determined at scanning points in the scanning surface 22. The exemplary embodiment illustrated here is concerned with the corner points of the scanning surface 22 of the object 15 (cf. FIG. 2C). In this case, the object heights extend along the z-axis. The object heights are determined using the particle beam, to be precise using the image sharpness of a small scanning region around a desired point, in this case for example a corner point. A small scanning region should be understood in this case to mean that the small scanning region comprises between 10·10 and 100·100 scanning points if the entire scanning surface 22 of the object is intended to be recorded using a scanning of 1000·1000 scanning points. The number of scanning points in a small scanning region is therefore less than 1/100 of the scanning points in the scanning surface 22 of which an image is intended to be generated or in which processing is intended to be effected. Basically, the image is focused and the parameters used for this purpose are stored. In order to focus the image, or to put it another way in order to find the focusing parameters necessary for a sharp image, a customary autofocus algorithm can be used. By way of example, using a Fourier analysis of two images recorded with two different parameter settings, it is possible to calculate in advance which parameter setting is required for a sharp image. Variables representing the object height at the previously mentioned point are obtained in this way. Thus, in a step S2, a first object height H1 is determined at a first scanning point R1 (for example a first corner point). In a further step S3, a second object height H2 is determined at a second scanning point R2 (for example a second corner point). A third object height H3 is determined at a third scanning point R3 (for example a third corner point) in a step S4. In turn, a fourth object height H4 is determined at a fourth scanning point R4 (for example a fourth corner point) in a step S5. In a further step S6, the abovementioned object heights H1 to H4 determined are stored, with assignment of the respective abovementioned scanning points R1 to R4 at which they were determined, in a database. The database is arranged in the electronic unit 18, for example.

In a step S7, a first focusing parameter f₀ is then determined using at least one of the object heights H1 to H4 determined in steps S2 to S5. Furthermore, in a step S8, a first correction parameter fₓ is determined using at least two of the abovementioned object heights H1 to H4. In this case, the first correction parameter fₓ is determined in such a way that it describes the change in the object height per unit length along the first axis in a manner dependent on the position along the first axis. Furthermore, in a step S9, a second correction parameter f_{y} is then determined using two of the abovementioned object heights H1 to H4. In this case, the second correction parameter f_{y} is determined in such a way that it describes the change in the object height per unit length along the second axis in a manner dependent on the position along the second axis. Furthermore, a third correction parameter f_{xy} is determined using at least three of the abovementioned object heights H1 to H4. The third correction parameter f_{xy} is determined such that it describes a torsion of the object surface between the first axis and the second axis.

An exemplary embodiment for determining the first focusing parameter and the correction parameters is explained in greater detail below. In this exemplary embodiment, it is assumed that the scanning surface 22 has a width B extending along the x-axis, and a length L extending along the y-axis.

Basically, the following conditions apply to the scanning surface 22:

0≦x≦B [condition 4], and

0≦y≦L [condition 5].

The coordinates of the previously mentioned scanning points R1, R2, R3 and R4 along the x-axis and y-axis (that is to say R(x, y)) are determined in this exemplary embodiment by

R1=R(0,0),

R2=R(B,0),

R3=R(0,L), and

R4=R(B,L).

At the previously mentioned scanning points R1, R2, R3 and R4, the respective object height H is determined—as already mentioned above. The following then hold true:

H1=H(0,0),

H2=H(B,0),

H3=H(0,L), and

H4=H(B,L),

where H1 is the object height determined at the first scanning point R1, H2 is the object height determined at the second scanning point R2, H3 is the object height determined at the third scanning point R3, and H4 is the object height determined at the fourth scanning point R4.

For the first focusing parameter mentioned further above and the correction parameters mentioned further above, the following then hold true in the exemplary embodiment illustrated here:

f₀=H1,

fₓ=(H2−H1)/B,

f_{y}=(H3−H1)/L, and

f_{xy}=(H4−H3−H2+H1)/(L·B).

In a further step S11, the particle beam is guided to an irradiation position in the form of a predefinable scanning point at a position (x, y) in the scanning surface 22. Using the parameters determined previously in steps S7 to S10, further focusing parameters are then determined, which are used for setting the focusing of the particle beam. Thus, in a step S12, a second focusing parameter (fₓ·x) is determined using the first correction parameter (fₓ) and the first position (x) along the x-axis. In a step S13, a third focusing parameter (f_{y}·y) is then determined using the second correction parameter (f_{y}) and the second position (y) along the y-axis. In yet another step S14, a fourth focusing parameter (f_{xy}·x·y) is then determined using the third correction parameter f_{xy}, the first position (x) along the x-axis and the second position (y) along the y-axis.

In a further step S15, the focusing of the particle beam is then set taking account of all the above-mentioned focusing parameters. This setting of the focusing is effected anew for each new scanning point. Afterward, in a step S16, the object is processed at the predefinable scanning point at the position (x, y). In addition or as an alternative thereto, provision is made for detecting interaction particles, in particular secondary electrons and/or backscattered electrons that arise on account of the interaction of the particle beam with the object 15, using the detector 17. The signals generated as a result in the detector 17 are used for imaging purposes. In addition or as an alternative thereto, interaction radiation can also be detected using a further detector, which is not illustrated. Said further detector is arranged, for example, between the objective lens 8 and the object 15.

In a further step S17, an interrogation is made as to whether the method is intended to be ended. If this is the case, the method is ended. If this is not the case, then the method returns to step S11 and the subsequent method steps are iterated anew.

FIG. 5 shows a second exemplary embodiment of a method according to the system described herein. In a step S100, firstly a particle beam in the form of an electron beam is generated by the beam generator 4. Afterward, in a step S101, the corresponding object heights are determined at a plurality of locations. By way of example, for all scanning points 24 of the scanning surface 22, the object height given at the respective scanning point 24 is determined. As an alternative thereto, provision is made, for example, for determining the object height given at the respective scanning point 24 only for a portion of the scanning points 24 (for example every second scanning point) of the scanning surface 22. Alternatively, provision is also made for determining object heights at locations on the surface 20 of the object 15, the locations not being arranged on the scanning surface 22. In this case, all of the object heights determined extend along the z-axis. The object heights are determined using the particle beam, in respect of which reference is also made to the text further above. In a further step S103, the abovementioned object heights determined are stored, with assignment of the respective abovementioned scanning points 24 or the locations at which they were determined, in a database. The database is arranged in the electronic unit 18, for example.

This is followed by then determining, in a step S104, an irradiation position in the form of a scanning point 24 of the scanning surface 22 to which the particle beam is guided and onto which the particle beam is intended to be focused.

In steps S105 to S108 that then follow, in this exemplary embodiment, at least four object heights are then chosen from the database. To put it another way, four object heights are then determined from the database. Thus, a step S105 involves determining a first object height from the database. A further step S106 involves determining a second object height from the database. Yet another step S107 involves determining a third object height from the database. A then further step S108 involves determining a fourth object height from the database.

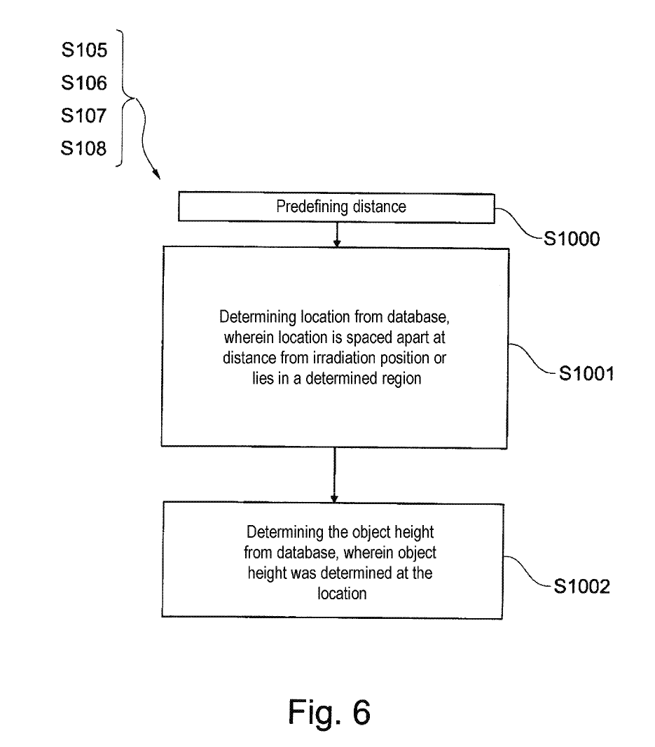

The determination of each of the abovementioned object heights in accordance with steps S105 and S108 can be effected, for example, in the manner as illustrated in greater detail in FIG. 6. In this embodiment, firstly a step S1000 involves predefining a distance which, for example, is in the region of an image field width or an image field length, or alternatively only in the region of half an image field width or half an image field length. However, the system described herein is not restricted to the abovementioned ranges. Rather, any suitable range can be used. In this case, one embodiment provides for restricting the range to a maximum of two image field widths or two image field lengths. A further step S1001 involves determining a location from the database, wherein said location is spaced apart for example at the predefined distance from the irradiation position (that is to say the scanning point) and/or is arranged in a region extending from the irradiation position as far as the distance. The location determined from the database in this way is assigned an object height determined in the database, namely the object height that was determined at the location determined. This object height is then used. In the manner mentioned above, for example the first object height (step S105), the second object height (step S106), the third object height (step S107) and the fourth object height (step S108) is/are determined.

A further embodiment provides for at least one of the abovementioned locations to be predefined in such a way that said location is arranged in the scanning surface 22. A further embodiment provides for at least one of the abovementioned locations to be arranged outside the scanning surface 22.

The further steps S7 to S17 of the method in accordance with FIG. 5 correspond to the steps S7 to S10 and S12 to S17 of the method in accordance with FIGS. 4A and 4B. Therefore, reference is made to the explanations above. In contrast to the method in accordance with FIGS. 4A and 4B, the method in accordance with FIG. 5 has a further interrogation in step S18, which, if appropriate, jumps to step S104.

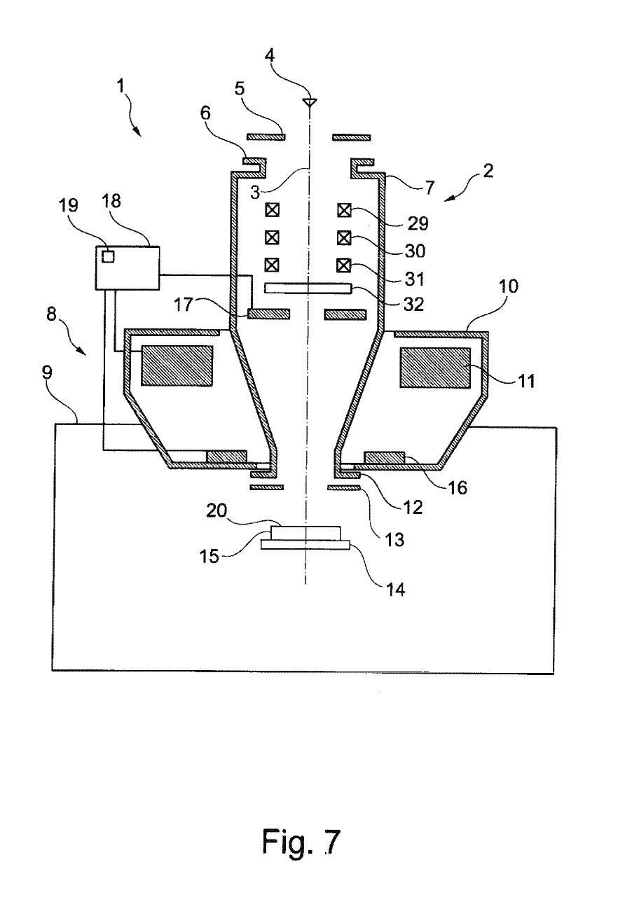

FIG. 7 shows a further embodiment of a particle beam device 1 based on the embodiment from FIG. 1. Identical components are therefore provided with identical reference signs. The embodiment in FIG. 7 differs from the embodiment from FIG. 1 to the effect that further components are additionally illustrated. Thus, FIG. 7 also shows a first condenser unit 29, a deflection device 30 and a second condenser unit 31, which are arranged along the optical axis 3 as viewed from the beam generator 4 in the direction of the objective lens 8. The first condenser unit 29 and the second condenser unit 31 serve for beam shaping. The deflection device 30 serves for directing the particle beam. In addition, the deflection device 30 can also be embodied as a focusing unit.

The exemplary embodiment in accordance with FIG. 7 furthermore has an image aberration correction device 32. The latter is arranged between the deflection device 30 and the objective lens 8. The image aberration correction device 32 serves to compensate for image aberrations that arise during the focusing of the particle beam onto the object 15. By way of example, the image aberration correction device 32 has a plurality of electrostatic and magnetic multi-pole elements. However, the embodiment of the image aberration correction device 32 is not restricted to the abovementioned embodiment. Rather, the image aberration correction device 32 can assume any suitable configuration. Examples of image aberration correction devices are known, for example, from U.S. Pat. No. 7,223,983 B2 for a multi-pole corrector and from U.S. Pat. No. 6,855,939 B2 for a mirror corrector, both of which are incorporated herein by reference.

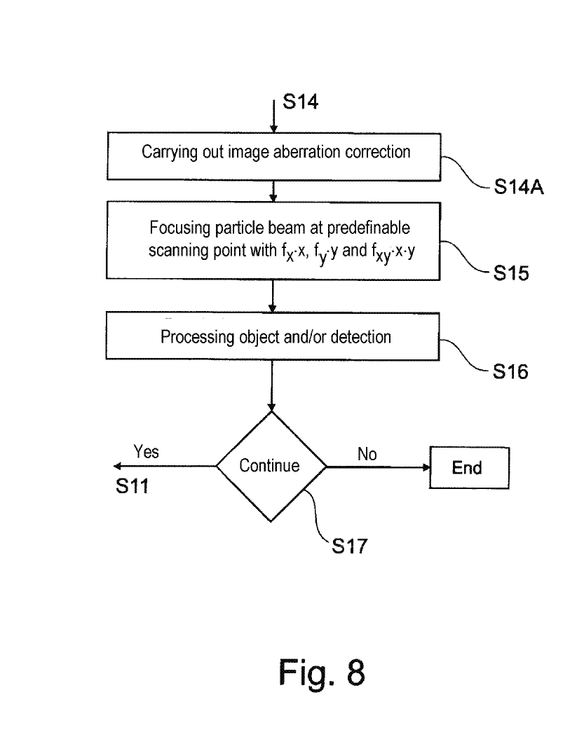

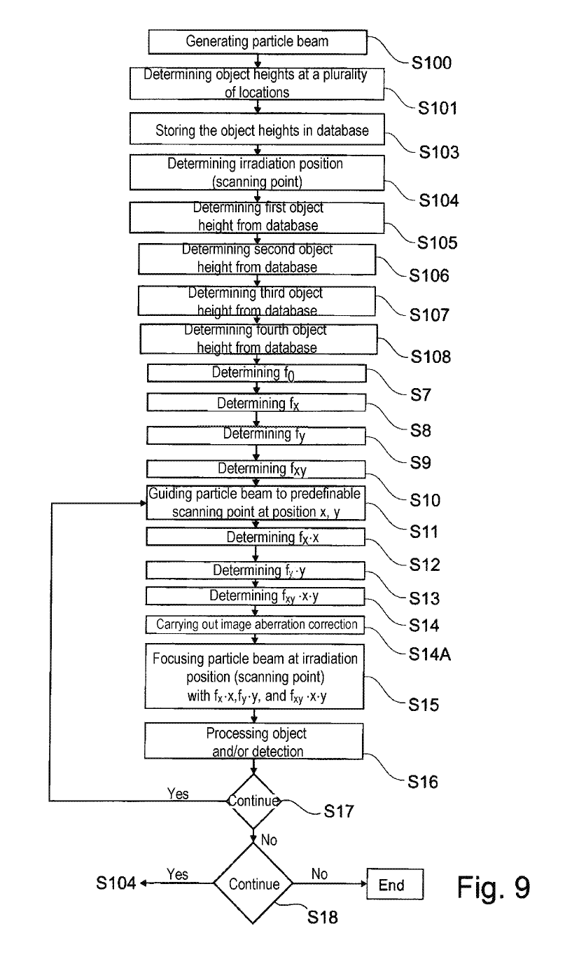

The two above-described embodiments of the method according to the system described herein can be carried out using the particle beam device illustrated in FIG. 7. For this purpose, provision is also made for the method in accordance with FIGS. 4A and 4B to have an additional step. FIG. 8 is based on FIG. 4B. In this exemplary embodiment, a further step S14A is inserted between step S14 and step S15, in which further step an image aberration correction is effected using the image aberration correction device 32. A modification of the method according to FIG. 5 is illustrated in FIG. 9. The method according to FIG. 9 differs from the method according to FIG. 5 only in that a further step S14A is inserted between step S14 and step S15, in which further step an image aberration correction is carried out using the image aberration correction device 32.

The first focusing parameter f₀, the second focusing parameter (fₓ·x), the third focusing parameter (f_{y}·y) and the fourth focusing parameter (f_{xy}·x·y) can always be chosen in such a way that a good focusing of the particle beam at any position on the surface 20 (for example a scanning point) is achievable. In this case, the focusing parameters are chosen in a manner dependent on the position on the surface 20 and the height profile of the object 15.

The methods also ensure that when the image aberration correction device 32 is used for increasing the resolution of imagings of the object 15 to be examined using the particle beam device 1, despite the large aperture angle of the particle beam that is required for this purpose and despite the smaller depth of focus caused as a result, a focusing is always chosen in such a way that a sharp imaging is achievable over the entire scanning region 22 of the object 15.

A further embodiment provides for storing the first focusing parameter determined and the correction parameters determined and also the focusing parameters determined as a result in a manner dependent on the height profile. These data can be used again at any time. If, by way of example, the object 15 is removed from the particle beam device 1 and introduced anew into the particle beam device 1, then it is highly likely that the position of the object 15 before the removal of the object 15 (first position) and the position of the object 15 after the renewed introduction of the object 15 into the particle beam device 1 (second position) will be different. However, the height profile of the object 15 has remained unchanged per se. The exemplary embodiment of the system described herein then provides for determining, on the basis of the previously determined correction parameters and the focusing parameters, new correction parameters and new focusing parameters for the second position of the object 15 after renewed introduction into the particle beam device 1. In this case, firstly a customary coordinate transformation between the first position and the second position is performed, wherein the following hold true for the coordinates X, Y in the second position:

X=x·cos θ−y·sin θ+X₀,

Y=x·sin θ+y·cos θ+Y₀,

where X₀ and Y₀ are the lateral displacements of the object between the first position and the second position, wherein x and y are coordinates in the first position, and wherein the angle θ describes a rotation of the object 15 from the first position into the second position.

Furthermore, the following correction hold true for the first focusing parameter and the correction parameters:

F₀=f₀+c₀,

Fₓ=fₓ+cₓ,

F_{y}=f_{y}+c_{y},

F_{XY}=f_{xy},

wherein F₀ denotes the first focusing parameter in the second position,
wherein Fₓ denotes the first correction parameter in the second position,
wherein F_{y} denotes the second correction parameter in the second position,
wherein F_{XY} denotes the third correction parameter in the second position,
wherein c₀ denotes the axial displacement of the object 15 along the z-axis (height change), wherein cₓ denotes the tilting of the object 15 with respect to the x-axis, and c_{y} denotes the tilting of the object 15 with respect to the y-axis.

Various embodiments discussed herein may be combined with each other in appropriate combinations in connection with the system described herein. Additionally, in some instances, the order of steps in the flowcharts, flow diagrams and/or described flow processing may be modified, where appropriate. Further, various aspects of the system described herein may be implemented using software, hardware, a combination of software and hardware and/or other computer-implemented modules or devices having the described features and performing the described functions. Software implementations of the system described herein may include executable code that is stored in a computer readable medium and executed by one or more processors. The computer readable medium may include volatile memory and/or non-volatile memory, and may include, for example, a computer hard drive, ROM, RAM, flash memory, portable computer storage media such as a CD-ROM, a DVD-ROM, a flash drive and/or other drive with, for example, a universal serial bus (USB) interface, and/or any other appropriate tangible or non-transitory computer readable medium or computer memory on which executable code may be stored and executed by a processor. The system described herein may be used in connection with any appropriate operating system.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A method for focusing a particle beam onto an irradiation position on a surface of an object and for imaging or processing the surface, wherein the surface extends along a first axis and along a second axis, the method comprising:
generating the particle beam;
determining at least one first object height, which extends along a third axis, at least one first location on the surface;
determining at least one second object height, which extends along the third axis, at least one second location on the surface;
determining at least one third object height, which extends along the third axis, at least one third location on the surface;
determining at least one first focusing parameter using at least one of the object heights;
determining at least one first correction parameter using at least one of the object heights;
determining at least one second correction parameter using at least one of the object heights;
guiding the particle beam to the irradiation position on the surface, wherein the irradiation position is predefined by a first position relative to the first axis and by a second position relative to the second axis;
determining a second focusing parameter using the first correction parameter and the first position;
determining a third focusing parameter using the second correction parameter and the second position;
focusing the particle beam at the irradiation position in a manner dependent on the first focusing parameter, the second focusing parameter and the third focusing parameter; and
performing at least one of: (i) processing the object at the irradiation position or (ii) detecting interaction particles or interaction radiation at the irradiation position, wherein the interaction particles or the interaction radiation arise on account of an interaction of the particle beam with the object at the irradiation position.

2. The method according to claim 1, further comprising:
determining at least one fourth object height, which extends along the third axis, at at least one fourth location on the surface;
determining at least one third correction parameter using at least one of the object heights;
determining a fourth focusing parameter using the third correction parameter, the first position and the second position; and
additionally focusing the particle beam at the irradiation position in a manner dependent on the fourth focusing parameter.

3. The method according to claim 1,
wherein focusing the particle beam at the irradiation position in a manner dependent on the first focusing parameter comprises a basic focusing of the particle beam at the irradiation position,
wherein focusing the particle beam at the irradiation position in a manner dependent on the second focusing parameter comprises focusing along the first axis, and
wherein focusing the particle beam at the irradiation position in a manner dependent on the third focusing parameter comprises focusing along the second axis.

4. The method according to claim 1, wherein at least one of the object heights is stored in a database.

5. The method according to claim 1, wherein the surface is delimited by at least one edge, and wherein the method further comprises at least one of the following:
(i) at least one of the locations is predefined in such a way that the at least one location is arranged in the surface; or
(ii) at least one of the locations is predefined in such a way that the at least one location is arranged outside the surface.

6. The method according to claim 1, further comprising:
at least one particle-optical unit that is used to focus the particle beam; and
an image aberration correction device, wherein image aberrations caused by the particle-optical unit are corrected using the image aberration correction device.

7. A non-transitory computer readable medium storing software that, when executed by at least one processor, provides for focusing a particle beam onto an irradiation position on a surface of an object and for imaging or processing the surface, wherein the surface extends along a first axis and along a second axis, the software comprising:
executable code that generates the particle beam;
executable code that determines at least one first object height, which extends along a third axis, at least one first location on the surface;
executable code that determines at least one second object height, which extends along the third axis, at least one second location on the surface;
executable code that determines at least one third object height, which extends along the third axis, at least one third location on the surface;
executable code that determines at least one first focusing parameter using at least one of the object heights;
executable code that determines at least one first correction parameter using at least one of the object heights;
executable code that determines at least one second correction parameter using at least one of the object heights;
executable code that guides the particle beam to the irradiation position on the surface, wherein the irradiation position is predefined by a first position relative to the first axis and by a second position relative to the second axis;
executable code that determines a second focusing parameter using the first correction parameter and the first position;
executable code that determines a third focusing parameter using the second correction parameter and the second position;
executable code that focuses the particle beam at the irradiation position in a manner dependent on the first focusing parameter, the second focusing parameter and the third focusing parameter; and
executable code that performs at least one of: (i) processing the object at the irradiation position or (ii) detecting interaction particles or interaction radiation at the irradiation position, wherein the interaction particles or the interaction radiation arise on account of an interaction of the particle beam with the object at the irradiation position.

8. A particle beam device, comprising
at least one beam generator for generating a particle beam;
at least one focusing device; and
at least one microprocessor and at least one non-transitory computer readable medium storing software that, when executed by the at least one microprocessor, provides for focusing the particle beam onto an irradiation position on a surface of an object and for imaging or processing the surface, wherein the surface extends along a first axis and along a second axis, the software comprising:
executable code that generates the particle beam;
executable code that determines at least one first object height, which extends along a third axis, at least one first location on the surface;
executable code that determines at least one second object height, which extends along the third axis, at least one second location on the surface;
executable code that determines at least one third object height, which extends along the third axis, at least one third location on the surface;
executable code that determines at least one first focusing parameter using at least one of the object heights;
executable code that determines at least one first correction parameter using at least one of the object heights;
executable code that determines at least one second correction parameter using at least one of the object heights;
executable code that guides the particle beam to the irradiation position on the surface, wherein the irradiation position is predefined by a first position relative to the first axis and by a second position relative to the second axis;
executable code that determines a second focusing parameter using the first correction parameter and the first position;
executable code that determines a third focusing parameter using the second correction parameter and the second position;
executable code that focuses the particle beam at the irradiation position in a manner dependent on the first focusing parameter, the second focusing parameter and the third focusing parameter; and
executable code that performs at least one of: (i) processing the object at the irradiation position or (ii) detecting interaction particles or interaction radiation at the irradiation position, wherein the interaction particles or the interaction radiation arise on account of an interaction of the particle beam with the object at the irradiation position.

9. The particle beam device according to claim 8, wherein one of the following is further provided:
(i) the focusing device is embodied as an objective lens, or
(ii) the particle beam device has an objective lens in addition to the focusing device.

10. The particle beam device according to claim 8, further comprising:
at least one deflection device; and
an image aberration correction device that is arranged between the deflection device and the focusing device.

11. A method for focusing a particle beam onto an irradiation position on a surface of an object and for imaging or processing the surface, wherein the surface extends along a first axis and along a second axis, the method comprising:
generating the particle beam;
determining object heights, which extend along a third axis, at a plurality of locations on the surface;
storing the object heights determined and the plurality of locations in a database, wherein each of the object heights determined is stored in a manner dependent on the location of the plurality of locations at which the object height was determined;
determining the irradiation position on the surface, wherein the irradiation position is predefined by a first position relative to the first axis and by a second position relative to the second axis;
determining at least three object heights from the stored object heights, the at least three object heights including a first object height, a second object height and a third object height;
determining at least one first focusing parameter using at least one of the object heights;
determining at least one first correction parameter using at least one of the object heights;
determining at least one second correction parameter using at least one of the object heights;
determining a second focusing parameter using the first correction parameter and the first position;
determining a third focusing parameter using the second correction parameter and the second position;
focusing the particle beam at the irradiation position in a manner dependent on the first focusing parameter, the second focusing parameter and the third focusing parameter; and
performing at least one of: (i) processing the object at the irradiation position or (ii) detecting interaction particles or interaction radiation at the irradiation position, wherein the interaction particles or the interaction radiation arise on account of an interaction of the particle beam with the object at the irradiation position.

12. The method according to claim 11, further comprising:
predefining at least one distance;
determining a first location, a second location and a third location from the database,
wherein at least one of the following locations, namely the first location, the second location and the third location, is spaced apart at the predefined distance from the irradiation position or is arranged in a region which extends from the irradiation position as far as the distance,
wherein the first object height is provided by the object height determined at the first location,
wherein the second object height is provided by the object height determined at the second location, and
wherein the third object height is provided by the object height determined at the third location.

13. The method according to claim 11, further comprising:
determining a fourth object height from the stored object heights, which extends along the third axis;
determining at least one third correction parameter using at least one of the object heights;
determining a fourth focusing parameter using the third correction parameter, the first position and the second position; and
additionally focusing the particle beam at the irradiation position in a manner dependent on the fourth focusing parameter.

14. The method according to claim 11,
wherein focusing the particle beam at the irradiation position in a manner dependent on the first focusing parameter comprises a basic focusing of the particle beam at the irradiation position,
wherein focusing the particle beam at the irradiation position in a manner dependent on the second focusing parameter comprises focusing along the first axis, and
wherein focusing the particle beam at the irradiation position in a manner dependent on the third focusing parameter comprises focusing along the second axis.

15. The method according to claim 11, wherein the surface is delimited by at least one edge, and wherein the method further comprises at least one of the following:
(i) at least one of the plurality of locations is predefined in such a way that the at least one location is arranged in the surface; or
(ii) at least one of the plurality of locations is predefined in such a way that the at least one location is arranged outside the surface.

16. The method according to claim 11, further comprising:
at least one particle-optical unit that is used to focus the particle beam; and
an image aberration correction device, wherein image aberrations caused by the particle-optical unit are corrected using the image aberration correction device.

17. A non-transitory computer readable medium storing software that, when executed by at least one processor, provides for focusing a particle beam onto an irradiation position on a surface of an object and for imaging or processing the surface, wherein the surface extends along a first axis and along a second axis, the software comprising:
executable code that generates the particle beam;
executable code that determines object heights, which extend along a third axis, at a plurality of locations on the surface;
executable code that stores the object heights determined and the plurality of locations in a database, wherein each of the object heights determined is stored in a manner dependent on the location of the plurality of locations at which the object height was determined;
executable code that determines the irradiation position on the surface, wherein the irradiation position is predefined by a first position relative to the first axis and by a second position relative to the second axis;
executable code that determines at least three object heights from the stored object heights, the at least three object heights including a first object height, a second object height and a third object height;
executable code that determines at least one first focusing parameter using at least one of the object heights;
executable code that determines at least one first correction parameter using at least one of the object heights;
executable code that determines at least one second correction parameter using at least one of the object heights;
executable code that determines a second focusing parameter using the first correction parameter and the first position;
executable code that determines a third focusing parameter using the second correction parameter and the second position;
executable code that focuses the particle beam at the irradiation position in a manner dependent on the first focusing parameter, the second focusing parameter and the third focusing parameter; and
executable code that performs at least one of: (i) processing the object at the irradiation position or (ii) detecting interaction particles or interaction radiation at the irradiation position, wherein the interaction particles or the interaction radiation arise on account of an interaction of the particle beam with the object at the irradiation position.

18. A particle beam device, comprising:
at least one beam generator for generating a particle beam;
at least one focusing device; and
at least one microprocessor and at least one non-transitory computer readable medium storing software that, when executed by the at least one microprocessor, provides for focusing a particle beam onto an irradiation position on a surface of an object and for imaging or processing the surface, wherein the surface extends along a first axis and along a second axis, the software comprising:
executable code that generates the particle beam;
executable code that determines object heights, which extend along a third axis, at a plurality of locations on the surface;
executable code that stores the object heights determined and the plurality of locations in a database, wherein each of the object heights determined is stored in a manner dependent on the location of the plurality of locations at which the object height was determined;
executable code that determines the irradiation position on the surface, wherein the irradiation position is predefined by a first position relative to the first axis and by a second position relative to the second axis;
executable code that determines at least three object heights from the stored object heights, the at least three object heights including a first object height, a second object height and a third object height;
executable code that determines at least one first focusing parameter using at least one of the object heights;
executable code that determines at least one first correction parameter using at least one of the object heights;
executable code that determines at least one second correction parameter using at least one of the object heights;
executable code that determines a second focusing parameter using the first correction parameter and the first position;
executable code that determines a third focusing parameter using the second correction parameter and the second position;
executable code that focuses the particle beam at the irradiation position in a manner dependent on the first focusing parameter, the second focusing parameter and the third focusing parameter; and
executable code that performs at least one of: (i) processing the object at the irradiation position or (ii) detecting interaction particles or interaction radiation at the irradiation position, wherein the interaction particles or the interaction radiation arise on account of an interaction of the particle beam with the object at the irradiation position.

19. The particle beam device according to claim 18, wherein one of the following is further provided:
(i) the focusing device is embodied as an objective lens, or
(ii) the particle beam device has an objective lens in addition to the focusing device.

20. The particle beam device according to claim 18, further comprising:
at least one deflection device; and
an image aberration correction device that is arranged between the deflection device and the focusing device.
